(19) United States
(12) Patent Application Publication
(10) Pub. No.: US 2007/0223369 A1
(43) Pub. Date: Sep. 27, 2007

(54) Cable misconnection detection system and method

(75) Inventor: Shinichiro Uekusa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/543,902

(22) Filed: Oct. 6, 2006

(30) Foreign Application Priority Data
Mar. 27, 2006 (JP) 2006-085656

(51) Int. Cl. H04J 3/14

(52) U.S. Cl. 370/217

(57) ABSTRACT

A duplex communication system provided with a first duplex apparatus (11) including two first apparatuses (12, 13) having the same functions and a second duplex apparatus (14) including two second apparatuses (15, 16) having the same functions, one of the first apparatuses of the first duplex apparatus and one of the second apparatuses of the second duplex apparatus being connected by cables (62, 63) for communications, wherein each of the first apparatuses and the second apparatuses is provided with an interface (61) with the opposing apparatus, each of the interfaces is provided with a working/standby information selector copying and outputting working information indicating that the data was output from the working apparatus or standby information indicating that the data was output from the standby apparatus from the data sent from the opposing apparatus, a working/standby information storage unit storing information for identifying whether its own system is working or standby, and a check unit comparing the information output from the working/standby selector and the information stored in the working/standby information storage unit and judging if its own system is normally connected to the opposing apparatus and a cable misconnection detection method relating to the same.

### BACKGROUND OF THE INVENTION

1. Field of the Invention

The present invention relates to a cable misconnection detection system and method in a cable-connected duplex communication system.

2. Description of the Related Art

When an electronic exchange or other trunk apparatus used for a communication network etc. stops due to a fault etc., many people are seriously inconvenienced, so a high reliability is sought from it. For this reason, in a trunk apparatus, a redundant configuration is adopted so that when a working system breaks down, a standby system is switched to so that the apparatus as a whole operates stably.

In the actual configuration of a communication network, a single trunk apparatus has a plurality of types of apparatuses and a plurality of apparatuses of the same type connected to it. The cables used for connecting the apparatuses are UTP cables or other such cables performing the transmission and reception by single cables or optical cables performing the transmission and reception by two cables. However, whichever cables are used, the greater the number of opposing apparatuses, the greater the number of cables used and the more complicated the connection work. If the cable connection work becomes complicated, the cable connection work becomes more susceptible to misconnection. The function of detection of cable disconnection and cable detachment is basically provided in the components performing the transmission. Detection of this is also easy. However, even if there is cable misconnection, since cables are connected, a function of detection of cable disconnection cannot confirm the cable misconnection.

As related art, see Japanese Patent Publication (A) No. 10-270120 and Japanese Patent Publication (A) No. 6-96812.

### SUMMARY OF THE INVENTION

An object of the present invention is to provide a cable misconnection detection system and method in a cable-connected duplex communication system.

To achieve the above object, according to a first aspect of the present invention, there is provided a duplex communication system comprising a first duplex apparatus including two first apparatuses having the same functions and a second duplex apparatus including two second apparatuses having the same functions, one of the first apparatuses of the first duplex apparatus and one of the second apparatuses of the second duplex apparatus being connected by cables for communications, wherein each of the first apparatuses and the second apparatuses comprises an interface with the opposing apparatus, each of the interfaces comprises a working/standby information selector copying and outputting working information indicating that the data was output from the working apparatus or standby information indicating that the data was output from the standby apparatus from the data sent from the opposing apparatus, a working/standby information storage unit storing information for identifying whether its own system is working or standby, and a check unit comparing the information output from the working/standby selector and the information stored in the working/standby information storage unit and judging if its own system is normally connected to the opposing apparatus.

In another aspect of the present invention, the check unit compares information output from the working/standby selector and information stored in the working/standby information storage unit and judges that connection is normal when the opposing apparatus is a working apparatus and its own apparatus is also a working apparatus. In still another aspect of the present invention, the check unit compares information output from the working/standby selector and information stored in the working/standby information storage unit and judges that misconnection has occurred in at least one of the case where the opposing apparatus is a working apparatus and its own apparatus is a standby apparatus and the case where the opposing apparatus is a standby apparatus and its own apparatus is a working system apparatus.

In another aspect of the present invention, the duplex apparatuses are telephone line electronic exchanges. In a still further aspect of the present invention, the duplex apparatuses are other trunk apparatuses.

According the present invention, a cable misconnection detection method using the above cable misconnection detection system is provided.

According to the present invention, each of the interfaces copies and outputs working information indicating that the data was output from the working apparatus or standby information indicating that the data was output from the standby apparatus from the data sent from the opposing apparatus, comparing the information output from the working/standby selector and the information stored in the working/standby information storage unit storing information for identifying whether its own system is working or standby, and judging if its own system is normally connected to the opposing apparatus, so there are the effects that is no need to store switching control signals, no trouble is involved, and misconnections can be reliably detected.

### BRIEF DESCRIPTION OF THE DRAWINGS

These and other objects and features of the present invention will become clearer from the following description of the preferred embodiments given with reference to the attached drawings, wherein:

FIG. 1 is a block diagram showing an example of the configuration of a conventional duplex communication system;

FIG. 2 is a block diagram explaining a switching control operation in the duplex apparatus shown in FIG. 1;

FIG. 3 is a block diagram explaining the flow of data in the system shown in FIG. 1;

FIG. 4 is a block diagram showing the state of connection of the working system 12 of the apparatus A and the standby system 16 of the apparatus B by cable misconnection;

FIG. 5 is a block diagram of a loopback system considered as a conventional misconnection detection method;

FIG. 6 is a block diagram of the general configuration of an interface in the cable misconnection detection system according to the present invention; and

FIG. 7A and FIG. 7B are flow charts for explaining the operation of the interface shown in FIG. 6.

### DESCRIPTION OF THE PREFERRED EMBODIMENTS

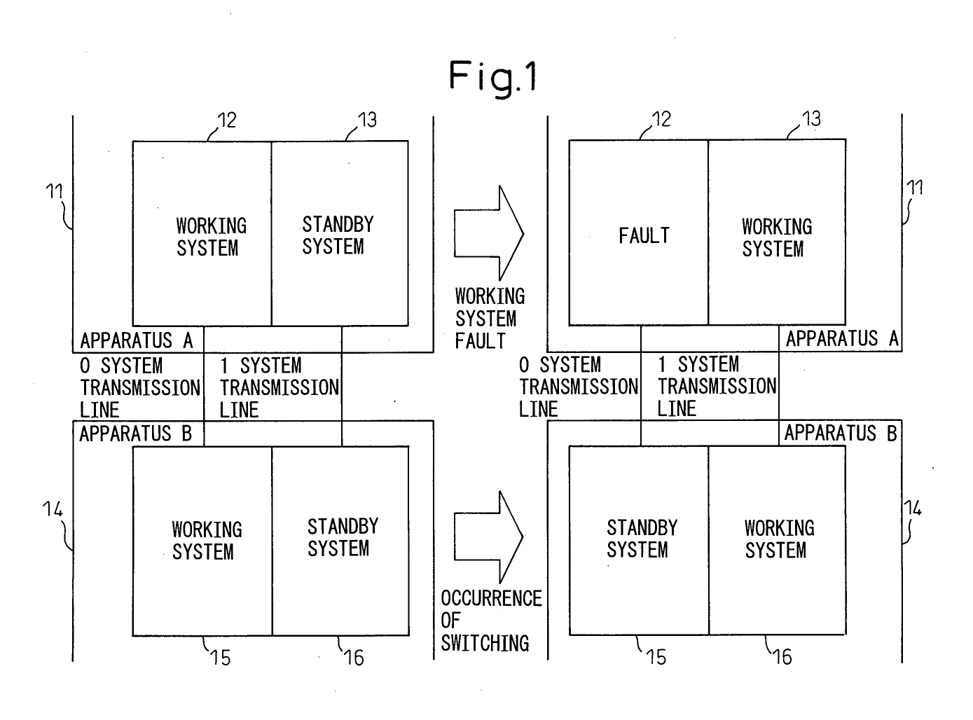

Below explained the preferred embodiments, the related art will explained in more detail with reference to the drawings. FIG. 1 is a block diagram showing an example of the configuration of a conventional duplex communication system. In the figure, 11 indicates an apparatus A which is provided with a working system apparatus 12 and a standby system apparatus 13. Reference numeral 14 indicates an apparatus B which is provided with a working system apparatus 15 and a standby system apparatus 16. The apparatus A and apparatus B are for example telephone line electronic exchanges or other trunk apparatuses and apparatuses where occurrence of a fault would be trouble any time during the 24 hours of the day. To deal with the occurrence of a fault, the apparatus A and apparatus B are also made duplex configurations of working systems (0 systems) and standby systems (1 systems).

When the apparatus interface function units employ redundant configurations of 0 system transmission lines and 1 system transmission lines in this way, when the working system of one system breaks down, the interface function unit switches to the standby system. Along with this, simultaneously the interface function unit of the opposing apparatus B side also switches from the working system to the standby system so that one working system and the other working system are always connected by cables.

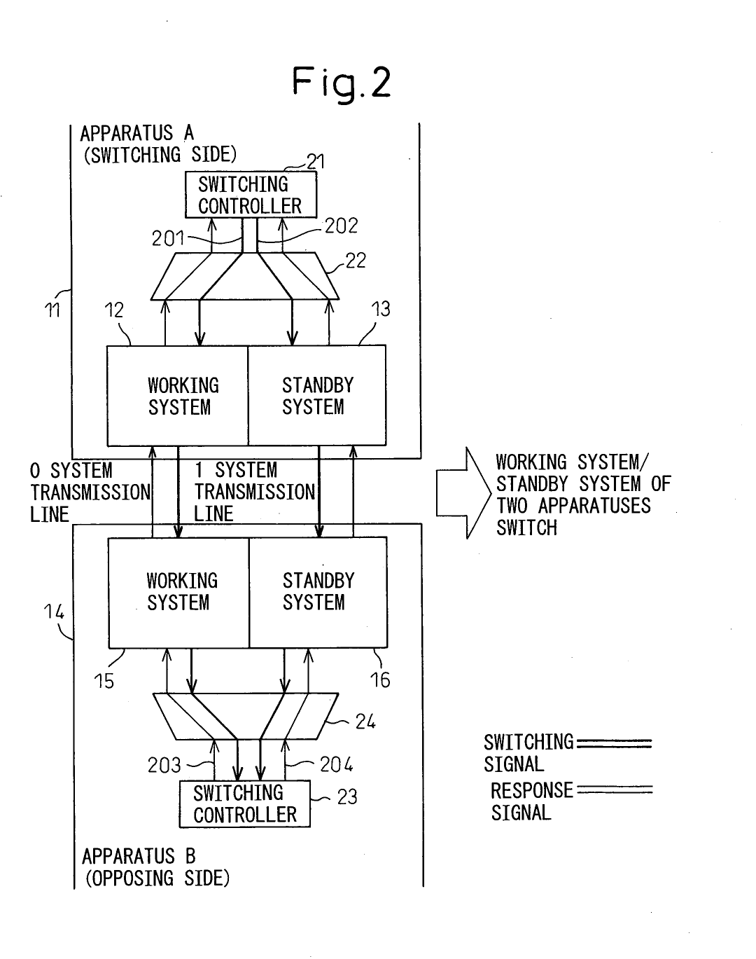

FIG. 2 is a block diagram for explaining the switching control operation in the duplex apparatus shown in FIG. 1. As illustrated, when the interface function unit switches between the working system and the standby system, the switching controller 21 of apparatus for which switching is desired, for example, the apparatus A, sends working system/standby system switching control information through the control lines 201 and 202 and the selectors 22 and 24. The response from the switching controller 23 of the opposing apparatus B side to the switching control is sent through the response signal lines 203 and 204 and the selectors 24 and 22 to the apparatus A desired to be switched to. This switching signal for the switching control and response signal to the switching control flow to both the working system and the standby system and include information showing whether the working transmission line requesting the switching is the 0 system or the 1 system, number of the working transmission line connected to the standby transmission line, type of switching request, etc.

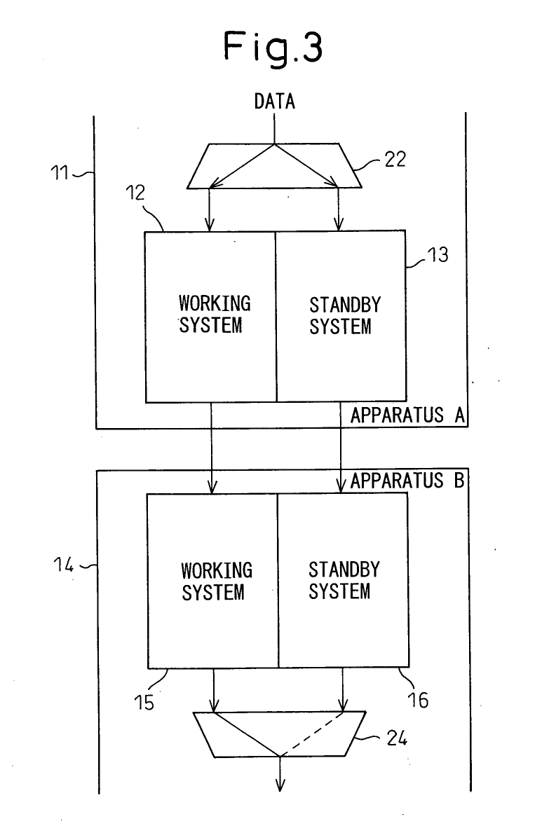

FIG. 3 is a block diagram for explaining the flow of data in the system shown in FIG. 1. As explained above, when a redundant configuration is employed, usually the same data is copied and flows to the working system and the standby system. The receiving side has a selector 24. The data from the standby system is discarded by the selector 24, and only the data from the working system is selected. In this way, even if for example data of the standby system ends up being cut off, no problem is caused.

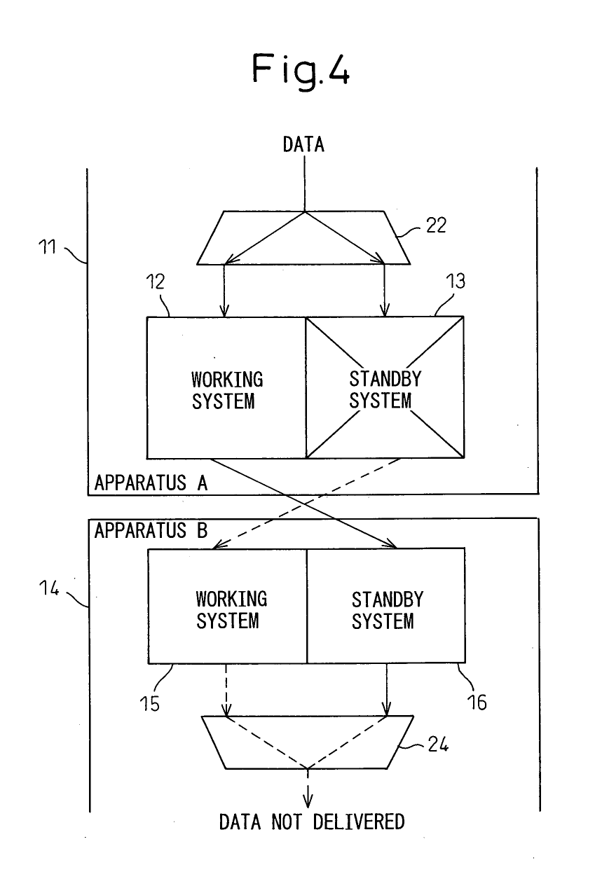

FIG. 4 is a block diagram showing the state where cable misconnection connects the working system 12 of the apparatus A and the standby system 16 of the apparatus B. In this way, if performing an action cutting off the data in the standby system apparatus 1 of the apparatus A in the misconnected state (reset, card exchange, self test, etc.), the data from the working system apparatus 12 of the apparatus A passes through the standby system apparatus 16 in the apparatus B and reaches the selector 24, but that data is discharged by the selector 24, so the data from the working system apparatus 12 of the apparatus A ends up being unable to reach the output of the selector 24 of the apparatus B and there is no longer any meaning in employing a redundant configuration.

Further, when this situation occurs, to judge that a cable has been misconnected, it is necessary to store all of the past occurring switching signals for switching control and response signals for switching control in a switching controller (not shown) and confirm if there is any contradiction in the information showing if the working transmission line requiring switching is the 0 system or 1 system and the number of the working transmission line connected to the standby transmission line. In practice, a memory area enough for storing all switching control signals is necessary. Further, it is necessary to confirm if there is any contradiction in the data stored in the memory area. This is all troublesome. Further, when there is no memory area, the problem remains that this cannot be determined at all.

When not storing all of the past occurring switching signals and response signals, in the worst case, the only method for determining misconnection ends up being going back over the cables. However, this method is not practical since the distance between trunk apparatuses (cable length) is sometimes long.

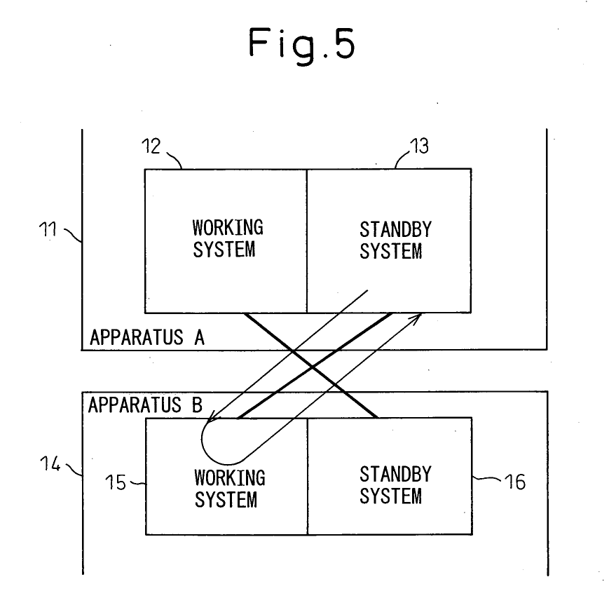

FIG. 5 is a block diagram showing a loopback system considered as a conventional misconnection detection method. In the figure, the working system apparatus 12 of the apparatus A and the standby system apparatus 16 of the apparatus B are misconnected and the standby system apparatus 13 of the apparatus A and the working system apparatus 15 of the apparatus B are misconnected. In this state, as one idea, it may be considered to transfer a loopback signal not including transmission line number information between the standby system apparatus 13 of the apparatus A and the working system apparatus 15 of the apparatus B. However, with this method, even if misconnected, the loopback signal normally returns to the sending side, so misconnection cannot be detected.

It may also be considered to insert the transmission line number information in the loopback signal in the loopback system. That is, it may be considered to set unambiguous numbers for the transmission lines to which the cables of the transmission line numbers are connected, impart them to empty regions of the loopback signal, and transmit the loopback signal in order to detect misconnection between apparatuses, but even with cable misconnection, the loopback signal ends up being normally returned to the sending side, so the only way misconnection can be detected is to check that the number of the transmission line to be connected at the opposing apparatus and the transmission line number given to the loopback signal match.

Further, with this method, it is necessary to determine the specifications for the unambiguous numbers given to the transmission lines between the opposing apparatuses. This is not practical if the opposing apparatus side does not have the function of detecting the numbers, so this cannot be said to be a realistic detection method. That is, the opposing apparatuses may be made by different manufacturers. The specifications are not necessarily standardized. In this way, a system assigning unambiguous numbers to the transmission lines is not realistic. Further, in actual communication network configurations, a single trunk apparatus has a plurality of types of apparatuses connected to it, so all the apparatuses to be connected have to be provided with this function. Therefore, this method is not realistic method.

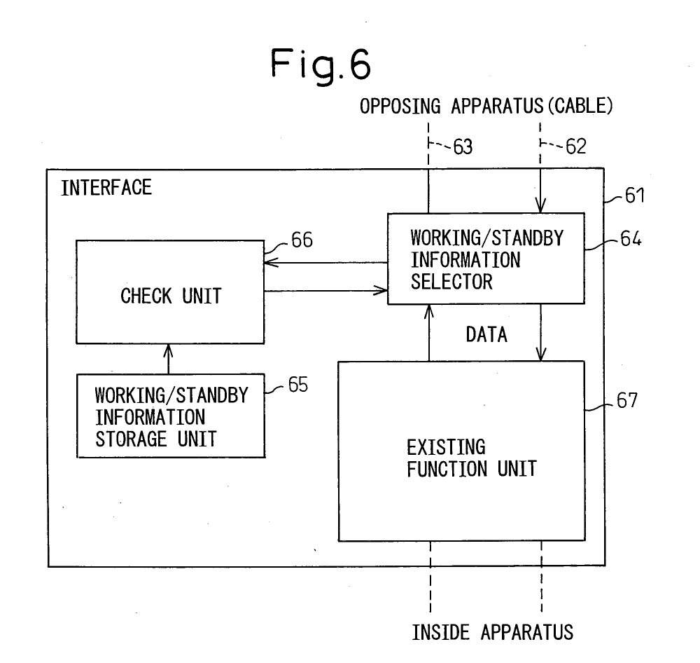

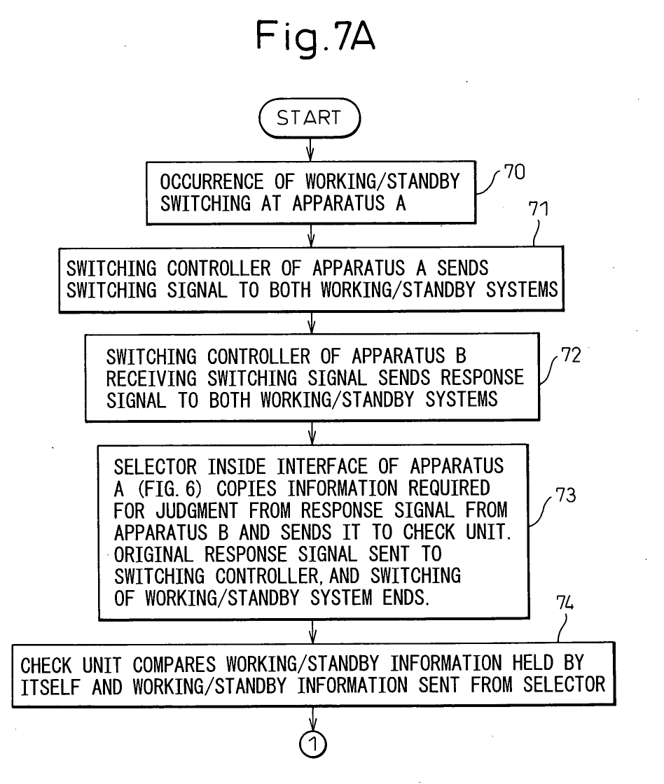

Below, an embodiment of the present invention will be explained in detail with reference to the drawings. FIG. 6 is a block diagram showing the general configuration of an interface of a cable misconnection detection system according to the present invention. In the figure, an interface 61 is provided between opposing apparatuses inside the first apparatuses 12, 13 and second apparatuses 15, 16 in a duplex communication system provided with a first duplex apparatus 11 including two first apparatuses 12 and 13 having the same functions shown in FIG. 1 and a second duplex apparatus 14 including two second apparatuses 15 and 16 having the same functions and connecting one of the first apparatuses 12, 13 in the first duplex apparatus 11 and one of the second apparatuses 15, 16 in the second duplex apparatus 14 by cables 62, 63 for communication.

The interface 61 is provided with a working/standby information selector 64 copying and outputting working information indicating that the data was output from the working apparatus or standby information indicating that the data was output from the standby apparatus from the data sent from the opposing apparatus, a working/standby information storage unit 65 storing information for identifying whether its own system is working or standby, and a check unit 66 comparing the information output from the working/standby selector 64 and the information stored in the working/standby information storage unit 65 and judging if its own system is normally connected to the opposing apparatus. Reference numeral 67 is an existing function unit in the interface 61. In the duplex communication system, parts other than the interface are configured the same as shown in FIG. 2. The same reference numerals will be assigned for the explanation.

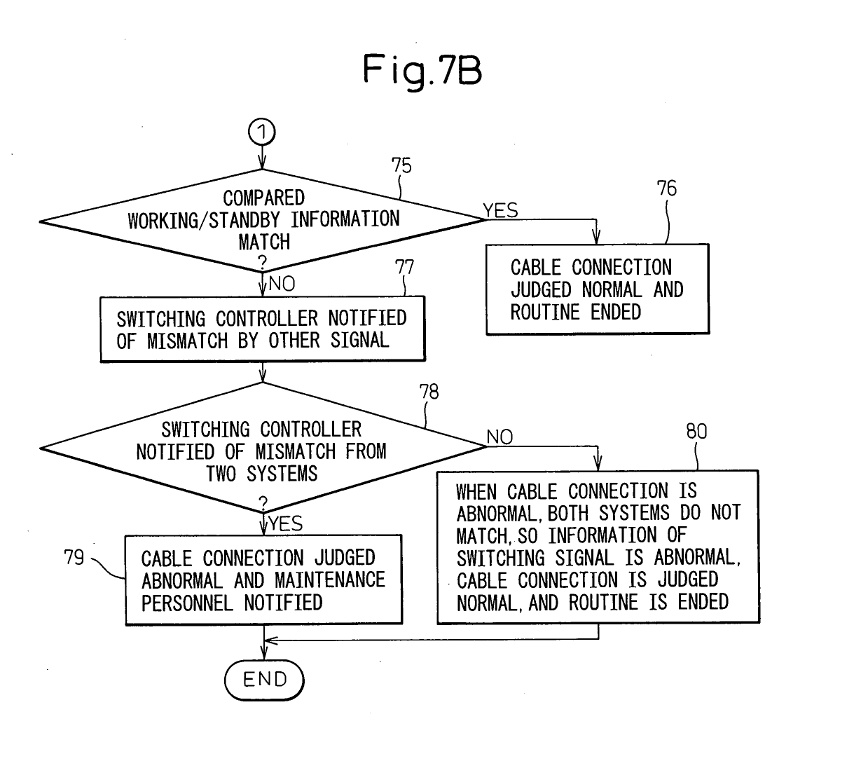

FIG. 7 7A and FIG. 7B are flow charts for explaining the operation of the interface 61 shown in FIG. 6. In FIG. 7A, at step 70, the apparatus A generates a switching signal of the working system and standby system. Next, at step 71, the switching controller 21 of the apparatus A sends the switching signal to the working/standby systems. Next, at step 73, the working/standby information selector 64 in each interface 61 (FIG. 6) of the working system apparatus 12 and standby system apparatus 13 of the apparatus A copies the information required for judgment from the response signal from the apparatus B and sends it to the check unit 66. The original response signal is returned to the switching controller 21 (FIG. 2), whereby the working/standby switching itself is ended.

Next, at step 74 in FIG. 7B, the check unit 66 compares the working/standby information stored in the working/standby information storage unit 65 and the working/standby information sent from the working/standby information selector 64. If the result is that they match, the routine proceeds to step 76, where it is judged that the cable connection is normal and the processing is ended.

When the result of the judgment at step 75 does not match, at step 77, the switching controller 21 (FIG. 2) is informed that they do not match by another signal. Next, at step 78, it is judged that the switching controller 21 is notified by the two systems that they do not match. When it is notified by the two systems that they do not match, at step 79, the cable connection is judged abnormal, the maintenance personnel is informed, and the processing ends.

When the result of judgment at step 75 is that only one system has given notification of a mismatch, at step 80 the cable connection is judged normal and the processing is ended. This is because when the cable connection is abnormal, both of the systems have mismatching working/standby information.

As the duplex apparatus in the above explanation, electronic exchanges and other trunk systems were mentioned, but the present invention may also be applied to any other duplex apparatuses.

According to the present invention, in a duplex trunk system, it is possible to simply detect misconnection without providing new cables and without requiring storage of past occurring switching signals and response signals and effectively detect misconnection of duplex apparatuses installed far from other each.

While the invention has been described with reference to specific embodiments chosen for purpose of illustration, it should be apparent that numerous modifications could be made thereto by those skilled in the art without departing from the basic concept and scope of the invention.

1. A duplex communication system comprising a first duplex apparatus including two first apparatuses having the same functions and a second duplex apparatus including two second apparatuses having the same functions, one of said first apparatuses of said first duplex apparatus and one of said second apparatuses of said second duplex apparatus being connected by cables for communications, wherein
each of said first apparatuses and said second apparatuses comprises an interface with the opposing apparatus,
each of said interfaces comprises:
a working/standby information selector copying and outputting working information indicating that said data was output from the working apparatus or standby information indicating that said data was output from the standby apparatus from the data sent from said opposing apparatus,
a working/standby information storage unit storing information for identifying whether its own system is working or standby, and
a check unit comparing the information output from said working/standby selector and the information stored in said working/standby information storage unit and judging if its own system is normally connected to said opposing apparatus.

2. A cable misconnection detection system as set forth in claim 1, wherein said check unit compares information output from said working/standby selector and information stored in said working/standby information storage unit and judges that connection is normal when said opposing apparatus is a working apparatus and its own apparatus is also a working apparatus.

3. A cable misconnection detection system as set forth in claim 1, wherein said check unit compares information output from said working/standby selector and information stored in said working/standby information storage unit and judges that misconnection has occurred in at least one of the case where said opposing apparatus is a working apparatus and its own apparatus is a standby apparatus and the case where said opposing apparatus is a standby apparatus and its own apparatus is a working system apparatus.

4. A cable misconnection detection system as set forth in claim 1, wherein said first duplex apparatus and said second duplex apparatus are telephone line electronic exchanges.

5. A cable misconnection detection system as set forth in claim 1, wherein said first duplex apparatus and said second duplex apparatus are trunk apparatuses.

6. A cable misconnection detection method in a duplex communication method for communication between one first apparatus in duplex apparatuses of a first duplex apparatus including two first apparatuses and one second apparatus in duplex apparatuses of a second duplex apparatus including two second apparatuses having the same functions connected by cables, wherein
each interface provided between opposing apparatuses among said first apparatuses and said second apparatuses performs,
a step of storing information for identifying if its own apparatus is a working or standby apparatus,
a step of copying and outputting working information indicating that said data was output from the working apparatus or standby information indicating that said data was output from the standby apparatus from the data sent from said opposing apparatus,
a step of comparing the information output from said working/standby selector and the information stored in said working/standby information storage unit and judging if its own system is normally connected to said opposing apparatus.

7. A cable misconnection detection method as set forth in claim 6, wherein said judgment step compares said output information and said stored information and judges that connection is normal when said opposing apparatus is the working apparatus and its own system is a working system.

8. A cable misconnection detection method as set forth in claim 6, wherein said judgment step compares said output information and said stored information and judges that misconnection has occurred in at least one of the case where said opposing apparatus is a working apparatus and its own apparatus is a standby apparatus and the case where said opposing apparatus is a standby apparatus and its own apparatus is a working system apparatus.

9. A cable misconnection detection method as set forth in claim 6, wherein said first duplex apparatus and said second duplex apparatus are telephone line electronic exchanges.

10. A cable misconnection detection method as set forth in claim 6, wherein said first duplex apparatus and said second duplex apparatus are trunk apparatuses.
